(19) United States
(12) Patent Application Publication
(10) Pub. No.: US 2004/0071891 A1
(43) Pub. Date: Apr. 15, 2004

(54) Process for applying exterior coatings to three dimensional containers

(75) Inventor: Gregory J. Luka, York, PA (US)

Correspondence Address: VENABLE, BAETJER, HOWARD AND CIVILETTI, LLP, P.O. BOX 34385, WASHINGTON, DC, 20043-9998, US

(73) Assignee: Graham Packaging Company, L.P., York, PA (US)

(21) Appl. No.: 10/352,909

(22) Filed: Jan. 29, 2003

Related U.S. Application Data
(60) Provisional application No. 60/352,246, filed on Jan. 29, 2002.

(51) Int. Cl. B05D 1/02

(52) U.S. Cl. 427/421; 427/553; 118/326

(57) ABSTRACT

An apparatus and method for applying a coating to an object such as a container or an injection blow molded bottle comprising initial staging of an object or container onto an application holding unit, which may employ a grounding pin or mechanism to allow for application of a solvent based coating by electrospray techniques, may further be capable of rotating the object or container during the spray application process and may further employ a positive registration means. The object may be spray coated while on the application holding unit. The object may be transferred to a secondary holding unit and subjecting the coated object to solvent evaporation. Initial curing of the coating by UV or infrared is performed while the object is on the secondary holding unit to the point where the object can rest on its base or a bearing surface without risking a loss of integrity of the coating. Finally, the object may be transferred to a final conveying unit, which may incorporate a positive registration means, for final mass curing by UV, infrared or convention heating.

This Application claims priority to U.S. Provisional Application No. 60/352,246, filed Jan. 29, 2002

### FIELD OF THE INVENTION

The invention relates generally to improving upon inefficiencies surrounding current technology incorporated for the spray application of solvent or water based coatings to containers, where the coatings are cured thermally or through ultra violet exposure.

### BACKGROUND OF THE INVENTION

In the bottle manufacturing industry, bottles move through various manufacturing steps suspended from chuck assemblies, which are themselves, moved by belt systems. One manufacturing step can include the application of a coating to a bottle. Such coatings can include resins to improve gas impermeability of the bottles, and coating to impart UV light protection or color to the bottle. Subsequent to application of a coating, the coating is cured. This can involve a pre-curing or initial step in which the solvent is evaporated, followed by one or more final curing steps. The sequence of applying and curing a coating is known not only in the bottle manufacturing industry, but in other applications as well. For example, U.S. Pat. Nos. 6,291,027, 6,231,932, 6,200,650 and 6,113,764 to Emch describe aspects of curing a coating on metal and polymer substrates, with particular focus on automobile parts.

Current technology for the application of exterior coatings to three dimensional objects, e.g. containers and bottles, incorporates the use of a chain on edge conveying system that carries the object to be coated on a continuous loop throughout the process. Examples of such systems are known, such as, for example, apparatuses developed by Feco (a Park Ohio company) and PPG. Such a system is shown in, for example, U.S. Pat. No. 5,769,476 to Lawn et al., which is incorporated herein by reference in its entirety.

These technologies force the user to shut down the system daily for prolonged maintenance and cleaning. Conventional systems incorporate one complete long “train,” where the container or object to be coated is mounted on a holder and remains on the same holder throughout the spraying, drying and curing process. The complete long train process requires machine designs to be more robust and costly while significantly increasing the size for a given cure time.

What is needed then, is an improved process that overcomes the shortcomings of conventional processes. For example, it would be desirable that a process be provided that avoids the necessity of daily maintenance shutdowns.

### SUMMARY OF THE INVENTION

As described further herein, an exemplary embodiment of the present invention overcomes problems inherent in the processes currently used for applying and curing a coating on a container. In particular, an exemplary embodiment of the present invention offers the advantages of:

1. Reducing the number of working holders within the system for a given throughput rate; and

2. Reducing the complexity of working holders by segregating the process into four phases, including:

a. Part loading and handling;

b. Solvent or water evaporation;

c. Rapid curing via infrared or UV to the point to which the part is dry enough to stand on its bearing surface; and

d. Mass conveying for drying via specialized curing ovens or infrared or UV exposure technologies.

A feature of an exemplary embodiment of the present invention includes incorporating multiple components and stages in the process. The multiple component and stage process allows components to be used, cleaned and maintained individually as needed. Advantageously, the multi-stage process reduces the need for continual handling and reduces cost and down time.

Additional advantages of the present invention over current technology include, for example:

Separate wet and dry zones;

decreased risk of bottle contamination with dust and airborne residue;

decreased holder maintenance resulting in savings in operation cost;

simple holder for second stage drying resulting in lower acquisition and maintenance costs;

possibility of incorporating an in-line cleaner for holders resulting in lower maintenance cost and shorter maintenance downtimes;

uniform load distribution; and

use of snap-fit holders for quick changeovers.

The invention is an apparatus for applying a coating to an object, for example a bottle, that includes an application holding unit for holding the object; a spray chamber, for example a spray booth in which the coating is applied to the object by spraying while the object is held on the application holding unit; a solvent evaporation region after the spray chamber; followed by an initial curing region; and a curing unit for curing the coating as the object is being conveyed on a final conveyor unit.

The application holding unit can include a grounding mechanism, for example a grounding pin to allow for electrostatic coating applications, and can also include a mechanism for rotating the object, while the object is in the spray, chamber and/or a positive registration mechanism. The apparatus can have a secondary holding unit for holding the object in the initial curing region that is different from the application holding unit. The secondary holding unit can, for example, hold the object in the solvent evaporation region and optionally, in the initial curing region.

The final conveying unit can include a positive registration mechanism. The initial curing region can be, for example, an infrared or UV radiation source, and the curing unit can be a convection oven or a UV or infrared radiation source.

In a method aspect, the invention is a method for applying a coating to an object. The method includes the steps of holding an object to be coated on an application holding unit; transporting the object into a spray chamber; and applying a coating to the object in the spray chamber by, for example, an electrospray process. The coating is cured and dried by allowing solvent to evaporate from the coating; initial curing of the coating until the object can rest on a bearing surface without loss of integrity of the coating; transferring the object to a final conveying unit, for example a conveyor belt; and final curing of the coating in a curing unit. The object can be transferred to a secondary holding unit before initial curing before or after solvent evaporation. In exemplary embodiments, the object is rotated as the coating is applied, during solvent evaporation and/or during initial and final curing.

Initial curing of the coating can be conducted by irradiating the coating with infrared or UV radiation and final curing can be conducted by heating or irradiating with UV or infrared radiation. The method can also include steps of cleaning the application holding unit after spray coating and before the application holding unit engages another of object. The objects coated according to the invention can be a container, for example a container formed by a blow molding process.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digits in the corresponding reference number.

### BRIEF DESCRIPTION OF THE DRAWINGS

FIG. 1 is a flow chart illustrating the steps involved in an exemplary embodiment of the coating process according to the present invention.

FIG. 2 illustrates an apparatus for spray coating a bottle and curing the spray coating.

FIG. 3 illustrates an exemplary embodiment of a structure of an injection blow molded container that may be coated according to the invention.

### DETAILED DESCRIPTION OF AN EXEMPLARY EMBODIMENT OF THE PRESENT INVENTION

An exemplary embodiment of the invention is discussed in detail below. While specific implementations are discussed, it should be understood that this is done for illustration purposes only. A person skilled in the relevant art will recognize that other components and configurations may be used without parting from the invention.

As previously stated, technologies for applying and curing coatings on containers such as those developed by Feco or PPG force the user to shut down daily for prolonged maintenance and cleaning. One reason for this disadvantage is the use of a single long “train” for conveying containers through the spraying and curing system. Specifically, in existing systems, a container is loaded onto a holder. The holder incorporates a grounding mechanism in order that the container may be electro-sprayed with a coating. After coating, the container remains mounted to the same holder throughout the curing process. Thus, to achieve a high throughput, there must be a sufficient number of holders to accommodate the total number of containers that may be at any stage in the process at any given time because a single holder is used throughout the entire process for each container, from application of a coating in a sprayer, to initial evaporation of water or other solvent, to initial drying and final curing.

Further, because each container remains attached to a single holder throughout the process, the holder is subject to the same conditions as the coating on the container. This is a particular disadvantage to systems using electrospray techniques. In these systems, the holder incorporates a grounding pin that is needed for the electrospray process. Although the grounding pin is not required for the solvent evaporation and curing process, it is nonetheless subject to the curing conditions. Another particular problem is that any over-spray, i.e. spray of the coating onto the holder, is subject to the same curing process, resulting in a coating of cured coating on a large number of holders.

To maintain such an apparatus, frequent shut-downs, for example, daily shutdowns, are required, particularly for cleaning. In order to clean any particular part of such an apparatus, the entire process must come to a halt, even if only a limited cleaning is required. This causes significant down-time. Further, in the event of a more extensive overhaul or maintenance, a large number of grounded holders may need to be replaced.

The present invention reduces the need for continual handling, reduces cost, and reduces down time by separating the process into stages that can be operated by incorporating various components, for example holders, only as needed. The invention incorporates a number of stages for the spray application and curing process. Each stage can incorporate a different holding unit for the object or container. For example, during the spraying, an application holding unit comprising a grounding pin can be used. During the solvent evaporation stage and/or during an initial curing stage, the objects or containers can be transferred to a secondary holding unit that need not have a grounding pin. During final curing, the object or container can be transferred to a conveyor holding unit. Because the initial curing process dries the exterior of the coating to the point where the object or container can rest on a bearing surface without loss of coating integrity, the conveyor may be, for example, a belt on which the object or container is set. Each holding unit can thus be of progressively simpler design. As a result, the total number of holding units in the invention can remain high, without having the more complex and expensive application holding occupied throughout the entire coating and curing process and without having the application holding unit exposed to the curing process.

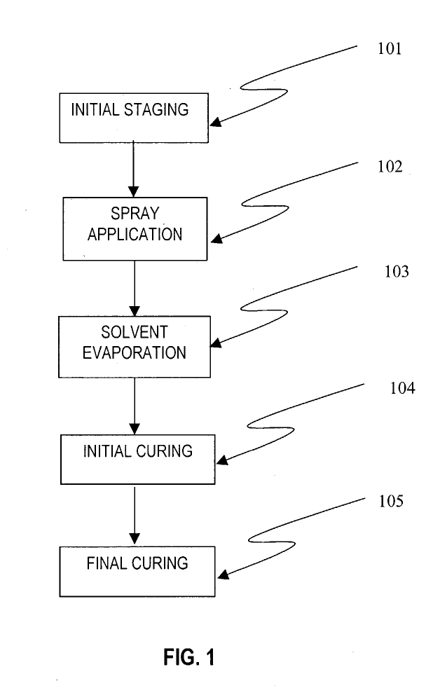

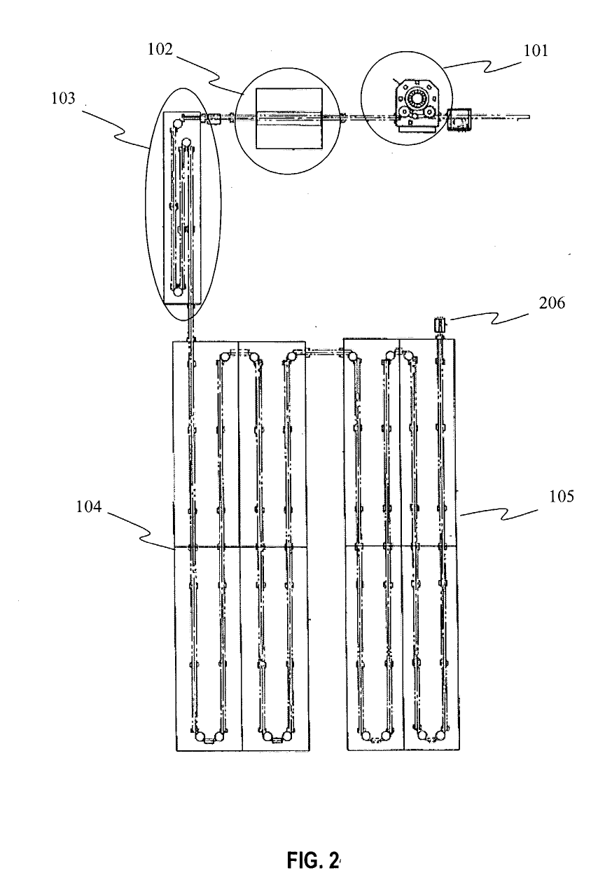

FIG. 1 is a flow chart illustrating the steps involved in the coating process according to the present invention. FIG. 2 illustrates an apparatus for spray coating a bottle and curing the spray coating. The references numbers in FIG. 1 refer to the various stages in the coating and curing process. The same reference numbers in FIG. 2 refer to the areas where each stage occurs in a conventional apparatus. FIG. 2 also includes a final stage of removing the containers 206.

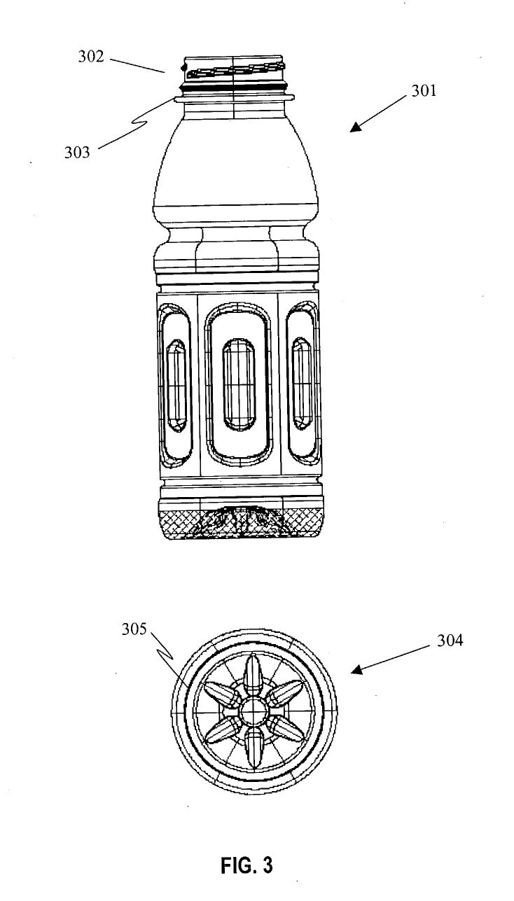

In a first staging area 101 according to the invention, articles, e.g. containers, are loaded onto a holding device. The holding device incorporates a number of individual application holding units, each of which can hold a single object or container to be coated. Each application holding unit can incorporate a grounding mechanism, for example a pin, to impart capabilities suitable for electrostatic spray applications. In addition, each application holding unit can provide a mechanism that rotates the object or containers during the spraying process. The loading device can provide a consistent loading repeatability by using a positive registration mark on the article similar. FIG. 3 illustrates the structure of an injection blow molded container that may be coated according to the invention. The container 301 of FIG. 3 may have an injection molded thread finish 302 with a support ring 303 as a positive registration mark, although other aspects can provide a positive registration mark.

Application holding units according to the invention are known in the art and can be identical or similar to holding units in apparatuses such as the Feco or PPG apparatus previously mentioned. These holding units are described in, for example, U.S. Pat. No. 5,769,476 to Lawn et al., U.S. Pat. No. 5,419,427 to Wurgler, U.S. Pat. No. 5,542,526 to Wurgler U.S. Pat. No. 4,640,406 to Willison, U.S. Pat. No. 4,927,205 to Bowler et al. and U.S. Pat. No. 5,558,200 to Whitby et al., each of which is incorporated herein by reference in its entirety. Existing apparatuses incorporate the features of the application holding units of the present invention. For example, existing apparatuses may provide a grounding mechanism that allows electro-spray application of one or more coatings. Existing apparatus also commonly employ a mechanism for rotating the object or container that is being coated.

The number of application holding units can be less than 50% of the total number of holding units, and may be as low as 25% or even less of the total number of holding units. The application holding units can be fitted to an articulated engineering chain that can be managed up to 360 degrees via cams to allow for complete rotation. The chains used may be of a similar construction as those used in existing spray coating apparatus (See, for example, U.S. Pat. Nos. 5,261,527 and 5,415,274 to Krismanth et al.), although in the present invention such a chain would not extend through the entirety of the apparatus.

With reference to FIG. 1, after staging onto the application holding units, the object or container enters a device 102, for example a chamber or booth, for spray application to provide a coating on the container or object. Typically, the coating that is applied to the container or object is a polymer, monomer, oligomer or polymer blend in a solvent. As previously described, the application holding units can include a mechanism for rotating the object or container during the spraying process. This allows the application of the coating to be done at any angle relative to the part being coated. Thus, depending on the shape or structural features of the object or container, the coating can be sprayed at a particular angle or in a particular fashion to assure a contiguous, even coating and to ease the capture of over spray or coating that is not applied to the article during the application process. This allows for capture and possible recycling of the overspray.

Again, the spray process may utilize application holding units and a spray chamber or device similar to those used in the apparatus available from Feco or PPG, identified above.

After spray application, the coated objects or containers are subject to a solvent evaporation stage 103. During the solvent evaporation stage 310, rotation of the objects or containers can continue to allow an even coating to form on the surface. As in a commercial apparatus such as, e.g., the Feco or PPG apparatus, the object or container can remain on the application holding unit. Alternatively, after coating, the object or container can be transferred to a secondary holding unit that can be simplified by having only the function of rotating and holding the article without the concern of incorporating grounding pins or similar devices necessary for electrostatic spray application. Otherwise, the secondary holding unit can be of a design similar to those described in the above referenced patents. The secondary holding unit can be designed such that the article can be rotated and air dried. The secondary holding unit design can therefore be simplified and the overall cost reduced relative to the application holding unit, because a grounding mechanism is not required. This phase of the process can employ secondary holding units that can comprise not greater than 40% of the total number of holding units and can comprise less than 25% of the total number of holding units.

One particular advantage to using a secondary holding unit is that the application holding units are not subject to drying or curing of the coating material. Hence, any over-spray that reaches the application holding unit can be removed by rinsing or another suitable mechanism. This prevents the build-up of coating material, particularly cured coating material, on the application holding units. Because the application holding units can incorporate more complex features, for example grounding pins or other grounding mechanism, ease of cleaning is advantageous. Furthermore, because there can be fewer application holding units for the same throughput in an apparatus according to the present invention, less frequent machine overhaul and shorter cleaning time is required. The presence of fewer application holding units thus reduces cost and downtime, should replacement of any portion of the holding units be required.

After solvent evaporation 103, the objects or containers are subject to an initial curing stage 104. During the initial curing stage 104, the coated objects or containers are dried to the point where the object or container can rest on its base or bearing surface without loss of integrity of the coating, for example by sticking to a conveying unit, or other device. The initial curing stage 104 is typically rapid and can be accomplished by, for example, UV or infrared radiation. During the initial curing stage 104, the object or container can remain on the application holding unit if no secondary holding unit is used during the solvent evaporation stage 103; be transferred to a secondary holding unit if no secondary holding unit is used during the solvent evaporation stage 103; remain on the secondary holding unit, if a secondary holding unit is used during the solvent evaporation stage 103; or transferred to a third holding unit. In exemplary embodiments of the invention, a secondary holding unit is used during the solvent evaporation stage 103 and the object or container remains attached to the secondary holding unit during the initial curing stage 104.

After the initial curing stage 104, the coated objects or containers are considered “semi-treated” and can rest on a base or bearing surface of the object or container. The objects or containers can thus be transferred from, for example, the secondary holding unit and placed on a final conveyor unit which can be, for example, a conveyor belt. On the final conveyor unit, the objects or containers are subject to the final curing stage 105. This can be considered a mass curing stage, because the process of the present invention allows for a tighter packing of objects or containers than achieved with a commercial apparatus such as the Feco or PPG apparatus identified above. The final curing stage 105 can, in particular, be operated by a time, temperature or ultraviolet exposure dependant process. During the final curing stage 105, the objects or containers can be convection heated with an engineered mass chain. Alternatively, the objects or containers can be subject to UV or infrared curing.

The final conveying unit can employ simple locating devices for the bottom registration point of the article to be cured. For example, in an injection blow molded container such as shown in FIG. 3, the base 304 can include a characteristic standing ring or heel portion 305 that may be positively engaged by the final conveying unit.

The use of a separate final curing stage allows for a long cure time. However, because of the tighter packing of objects or containers, the size of the curing unit can be reduced relative to a commercial apparatus such as the Feco or PPG system identified above. This reduces system size requirements and overall cost. The size of the curing unit is dependant upon the through-put requirements but, in general, mass curing time can be reduced by up to 30%. In exemplary embodiments, mass curing time can be reduced by up to 50% of the total time. This results in a reduction of systems size and complexity by up to 30% and possibly by as much as 50% or more.

In summary, an exemplary embodiment of the invention may involve the following steps:

1) Initial staging of an object or container onto an application holding unit which can employ a grounding pin or mechanism to allow for application of a solvent based coating by electro-spray techniques. The application holding unit can be capable of rotating the object or container during the spray application process and can further employ a positive registration means;

2) While on the application holding unit, applying a coating to the object or container;

3) Transferring the object or container to a secondary holding unit and subjecting the coated object or container to solvent evaporation;

4) Initial curing of the coating by UV or infrared while on the secondary holding unit to the point where the object or container can rest on its base or bearing surface without loss of integrity of the coating; and

5) Transferring the object or container to a final conveying unit, which can incorporate a positive registration means, for final mass curing by UV, infrared, or convention heating.

The embodiments illustrated and discussed in this specification are intended only to teach those skilled in the art the best way known to the inventors to make and use the invention at the time of filing. Nothing in this specification should be considered as limiting the scope of the present invention. All examples are representative and non-limiting. The above described exemplary embodiments of the invention may be modified or varied, without departing from the invention, as appreciated by those skilled in the art in light of the above teachings. It is therefore understood that, within the scope of the claims and their equivalents, the invention may be practiced otherwise than as specifically described.

What is claimed is:

1. An apparatus for applying a coating to an object comprising:
an application holding unit for holding an object to be coated;
a spray chamber for applying a coating to said object by spraying while said object is held by said application holding unit;
a solvent evaporation region after the spray chamber;
an initial curing region after the solvent evaporation region;
a final conveyor unit for conveying said object after said initial curing region; and
a curing unit for curing said coating on said object while said object is being conveyed by said final conveyor unit.

2. The apparatus of claim 1 further comprising, a secondary holding unit for holding said object in said initial curing region.

3. The apparatus of claim 2, wherein the secondary holding unit holds said object in the solvent evaporation region.

4. The apparatus of claim 1, wherein the application holding unit further comprises a grounding mechanism to allow for electro-spraying of said coating in said spray chamber.

5. The apparatus of claim 4, wherein the grounding mechanism is a grounding pin.

6. The apparatus of claim 1, wherein the application holding unit further comprises a mechanism for rotating said object while in said spray chamber.

7. The apparatus of claim 1, wherein said application holding unit further comprises a positive registration mechanism.

8. The apparatus of claim 1, wherein said final conveying unit further comprises a positive registration mechanism.

9. The apparatus of claim 1, wherein said initial curing region comprises an infrared or UV radiation source.

10. The apparatus of claim 1, wherein the curing unit comprises a convection oven.

11. The apparatus of claim 1, wherein said curing unit comprises a UV or infrared radiation source.

12. A method for applying a coating to an object comprising:
holding an object to be coated on an application holding unit;
transporting said object on said application holding unit into a spray chamber;
applying a coating to said object by spraying in said spray chamber;
allowing a solvent to evaporate from said coating;
initial curing of said coating until said object can rest on a bearing surface of said object without loss of integrity of said coating;
transfer of said object to a final conveying unit; and
final curing of said coating in a curing unit.

13. The method of claim 14, further comprising transferring said object to a secondary holding unit before initial curing of said coating.

14. The method of claim 15, wherein said object is transferred to said secondary holding unit before solvent evaporation.

15. The method of claim 14, further comprising rotating said object while applying said coating.

16. The method of claim 14, wherein applying said coating comprises electro-spraying.

17. The method of claim 14, wherein initial curing of said coating comprises irradiating said coating with infrared or UV radiation.

18. The method of claim 14, wherein final curing of said coating comprises heating said coating or irradiating said coating with UV or infrared radiation.

19. The method of claim 14, further comprising cleaning said application holding unit after spraying said coating and before said application holding unit engages another of said objects.

20. The method of claim 14, wherein said object is a container.

21. The method of claim 22, wherein said container is formed by an injection blow molding process.

22. The method of claim 14, further comprising positively registering said object on wherein at least one of said application holding units or said final conveyor units.
